(19) United States
(12) Patent Application Publication
(10) Pub. No.: US 2026/0188545 A1
(43) Pub. Date: Jul. 2, 2026

(54) NdFeB MAGNET AND PREPARATION METHOD

(71) Applicants: Ningbo Konit Industries Inc., Ningbo (CN); Ningbo Konit HEFENG NEW Material Co.,Ltd., Ningbo (CN); Ningbo Konit Xinfeng Precision Manufacturing Co., Ltd., Ningbo (CN); Ningbo Konit & Nihon Magnetic Material Inc., Ningbo (CN); BEIJING ZHONG KE SAN HUAN HI-TECH CO., LTD., Beijing (CN)

(72) Inventors: Fangyun WEI, Ningbo (CN); Dengxing WANG, Ningbo (CN); Chenchen LIU, Ningbo (CN); Guoan CHEN, Beijing (CN); Fei LI, Beijing (CN); Fei DU, Beijing (CN); Zhan WANG, Beijing (CN); Die HU, Beijing (CN)

(21) Appl. No.: 19/436,423

(22) Filed: Dec. 30, 2025

(30) Foreign Application Priority Data
Dec. 30, 2024 (CN) 202411973149.8

(51) Int. Cl. H01F 1/057; B22F 3/16; B22F 3/24; B22F 9/00; B22F 9/02; B22F 9/04; C22C 38/00; C22C 38/06; C22C 38/10; C22C 38/14; C22C 38/16

(52) U.S. Cl. CPC H01F 1/057; B22F 3/16; B22F 3/24; B22F 9/008; B22F 9/023; B22F 9/04; C22C 38/002; C22C 38/005; C22C 38/06; C22C 38/10; C22C 38/14; C22C 38/16; B22F 2003/248; B22F 2009/044; B22F 2301/355; B22F 2304/10; B22F 2998/10; B22F 2999/00; C22C 2202/02

(57) ABSTRACT

A NdFeB magnet includes main phase grains, thin-layer grain boundary phases, and triangular grain boundary phases, and includes 28 to 32 wt % of R, 0.84 to 0.94 wt % of B, 0.05 to 1 wt % of Co, 0.05 to 0.55 wt % of Cu, 0.3 to 0.6 wt % of Ga, 0 to 0.55 wt % of M2, 0.1 to 0.6 wt % of M3, and 66 to 70 wt % of Fe. R represents a rare earth element, and includes Pr and Nd. M2 represents one or more of Al and Sn. M3 represents one or more of Zr and Ti. The triangular grain boundary phases include R₆T₁₃M₁ phase. M includes two or more of Al, Cu, Ga, Ti, Sn, and/or Zr. T includes Fe and/or Co. The total area of the R₆T₁₃M₁ phase within the microscopic structure cross-section of the NdFeB magnet is in a range of 5.2% to 8.4% of the total area of the microscopic structure cross-section.

### CROSS-REFERENCE TO RELATED APPLICATION

This application claims priority to Chinese Application No. 202411973149.8, filed on Dec. 30, 2024, the entire content of which is incorporated herein by reference.

### TECHNICAL FIELD

The present disclosure relates to the field of NdFeB magnets and, in particular, to a NdFeB magnet and its preparation method.

### BACKGROUND

Since the advent of rare earth magnetic materials, they have been widely used in various industries such as energy, transportation, machinery, medical devices, and household appliances due to their excellent magnetic properties. Their applications extend across numerous sectors of the national economy. Currently, the rapid advancements in fields such as electric vehicles and wind power generation have led to an increasing demand for improvements in the performance of permanent magnets.

Due to the numerous applications of neodymium-iron-boron (NdFeB) sintered magnets in high-temperature environments, there is a requirement for these materials to possess not only high remanence but also high coercivity. Coercivity is a key parameter of permanent magnets; the higher the coercivity, the greater the resistance to demagnetization. In practical applications, it is preferable for NdFeB sintered magnets to have high coercivity, as this ensures good temperature stability and allows the magnets to operate under elevated temperature conditions.

Common methods for enhancing the coercivity of NdFeB sintered magnets include the substitution of neodymium (Nd) with dysprosium (Dy) and terbium (Tb) to improve coercivity. However, the availability of heavy rare earth elements like Dy and Tb is limited, and their costs are high, which can also lead to a reduction in the remanence of the magnets. Furthermore, heavy rare earth elements such as Dy and Tb are susceptible to fluctuations in pricing due to rare earth policies, which can result in price instability or significant volatility.

Therefore, it is a pressing challenge in the field to develop rare earth permanent magnets that maintain good remanence, coercivity, and consistency in squareness without the addition of heavy rare earth elements or with minimal use of such materials.

### SUMMARY

A first aspect of the present disclosure provides a neodymium-iron-boron (NdFeB) magnet, which includes main phase grains, thin layer grain boundary phases, and triangular grain boundary phases. The NdFeB magnet comprises R, B, Co, Cu, Ga, M2, M3 and Fe. The content of R is in the range of 28 to 33 wt %. The content of B is in the range of 0.84 to 0.94 wt %. The content of Co is in the range of 0.05 to 1 wt %. The content of Cu is in the range of 0.05 to 0.55 wt %. The content of Ga is in the range of 0.3 to 0.6 wt %. The content of M2 is in the range of 0 to 0.55 wt %, where M2 is selected from one or both of Al and Sn. The content of M3 is in the range of 0.1 to 0.6 wt %, where M3 is selected from one or both of Zr and Ti. The content of Fe is in the range of 66 to 70 wt %.

R represents rare earth element that includes at least Pr and Nd. The triangular grain boundary phase includes an R₆T₁₃M₁ phase, which contains M and T. M includes two or more elements selected from Al, Cu, Ga, Ti, Sn, and/or Zr. T includes Fe and/or Co. The percentage of the sum of the areas of all R₆T₁₃M₁ phases within the cross-section of the microstructure of the NdFeB magnet relative to the total area of the cross-section of said microstructure ranges from 5.20% to 8.40%.

According to an embodiment of the present disclosure, the NdFeB magnet comprises R, B, Co, Cu, Al, Ga, M3 and Fe. The content of R is in the range of 28 to 31 wt %. The content of B is in the range of 0.84 to 0.92 wt %. The content of Co is in the range of 0.05 to 0.6 wt %. The content of Cu is in the range of 0.3 to 0.55 wt %. The content of Al is in the range of 0 to 0.35 wt %. The content of Ga is in the range of 0.3 to 0.48 wt %. The content of M3 is in the range of 0.15 to 0.3 wt %. The content of Fe is in the range of 66 to 70 wt %.

According to an embodiment of the present disclosure, the distribution of the triangular grain boundary phase satisfies: the percentage of the area of all triangular grain boundary phases within the cross-section of the microstructure of the NdFeB magnet relative to the total area of said cross-section ranging from 6.5% to 8.5%; and the triangular grain boundary phase including the R₆T₁₃M₁ phase and the R-rich phase, the distribution of the R₆T₁₃M₁ phase satisfying: in the microstructural cross-section of the NdFeB magnet, the percentage of the total area of all R₆T₁₃M₁ phases in the total area of the cross-section ranging from 5.90% to 8.4%.

According to an embodiment of the present disclosure, the R₆T₁₃M₁ phase includes Cu, and the average atomic percentage of the Cu in the R₆T₁₃M₁ phase ranges from 1.5% to 7%.

According to an embodiment of the present disclosure, the R-rich phase includes Cu, and the average atomic percentage of the Cu in the R-rich phase ranges from 3.5% to 11%, in some embodiments from 3.50% to 7.60%.

According to an embodiment of the present disclosure, the R₆T₁₃M₁ phase includes Co, and the average atomic percentage of the Co in the R₆T₁₃M₁ phase ranges from 0.5% to 4%.

According to an embodiment of the present disclosure, the R-rich phase includes Ga, and the average atomic percentage of the Ga in the R-rich phase ranges from 0.3% to 1.5%.

According to an embodiment of the present disclosure, the NdFeB magnet comprises R, B, Al, Ga, Co, Cu, and Fe. The content of R is in the range of 29.5 to 32 wt %. The content of B is in the range of 0.84 to 0.92 wt %. The content of Al is in the range of 0.3 to 0.55 wt %. The content of Ga is in the range of 0.3 to 0.48 wt %. The content of Co is in the range of 0.05 to 0.6 wt %. The content of Cu is in the range of 0.05 to 0.3 wt %. The content of Fe is in the range of 66 to 70 wt %.

According to an embodiment of the present disclosure, the distribution of the R₆T₁₃M₁ phase satisfies: the percentage of the area of all R₆T₁₃M₁ phases within the cross-section of the microstructure of the NdFeB magnet relative to the total area of said cross-section ranging from 5.3% to 7.9%.

According to an embodiment of the present disclosure, the M in the R₆T₁₃M₁ phase contains Ga. [Ga] represents the atomic percentage of Ga in the R₆T₁₃M₁ phase, and [M] represents the atomic percentage of the M in the R₆T₁₃M₁ phase. The ratio of [Ga]/[M] is in the range of 0.49 to 0.61.

According to an embodiment of the present disclosure, the M in the R₆T₁₃M₁ phase contains Al. [Al] represents the atomic percentage of Al in the R₆T₁₃M₁ phase, and [M] represents the atomic percentage of the M element in the R₆T₁₃M₁ phase. The ratio of [Al]/[M] is in the range of 0.32 to 0.45.

According to an embodiment of the present disclosure, R does not contain heavy rare earth elements.

A second aspect of the present disclosure provides a method for preparing a NdFeB magnet, which includes the following steps:
producing rapidly solidified alloy sheets from alloy raw materials using a rapid solidification process;
subjecting the rapidly solidified alloy sheets to hydrogen explosion milling and air jet milling to obtain alloy powder, where the average particle size D50 of the alloy powder is between 3 and 5 m;
pressing the alloy powder into shape under magnetic field orientation, with a magnetic field strength of 1.4 to 2.5 T, to obtain a green compact, or performing isostatic pressing after pressing the alloy powder into shape under magnetic field orientation to obtain a green compact;
placing the green compact into a sintering furnace and conducting sintering and aging process in a vacuum or inert atmosphere to obtain the NdFeB magnet;
where the aging process is a three-stage aging process: the first stage aging performed at a temperature in a range of 800 to 950° C. with a holding time of 0.5 to 4 hours; second stage aging performed at a temperature in a range of 450 and 550° C. with a holding time of 2 to 10 hours; and the third stage aging performed at a temperature in a range of 600 and 700° C., with a holding time of 2 to 10 hours.

According to an embodiment of the present disclosure, the aging process includes the following steps: cooling to a temperature range of 150 to 250° C. after the second stage aging, with a cooling rate of 3 to 8° C./min; and cooling to room temperature after the third stage aging, with a cooling rate of 3 to 8° C./min.

The present disclosure optimizes the microstructural organization of the NdFeB magnet by reasonably controlling the content of elements such as B, Cu, Co, and Al in the raw material composition, in conjunction with a two-stage sintering and/or three-stage aging process. In particular, the three-stage aging heat treatment can further promote intergranular reactions, which not only increases the proportion of the R₆T₁₃M₁ phase but also facilitates the redistribution of elements such as Cu and Co. This method effectively enhances the coercivity of the NdFeB magnet while minimizing or eliminating the addition of heavy rare earth elements.

### BRIEF DESCRIPTION OF THE DRAWING

The figures included in this present disclosure are provided to enhance the understanding of the present disclosure. The illustrative embodiments and their descriptions herein are intended to elucidate the present disclosure and do not impose any undue limitations thereon.

FIG. 1 is an SEM image of the NdFeB magnet prepared in Embodiment 1-1 of the present disclosure.

FIG. 2 is an SEM image of the magnet prepared in Comparative Embodiment 1-1 of the present disclosure.

FIG. 3 is an SEM image of the NdFeB magnet prepared in Embodiment 2-1 of the present disclosure.

FIG. 4 is an SEM image of the magnet prepared in Comparative Embodiment 2-1 of the present disclosure.

### DETAILED DESCRIPTION OF EMBODIMENTS

The following detailed description of specific embodiments of the present disclosure is made in conjunction with the accompanying drawings. It should be understood that the specific embodiments described herein are for illustrative and explanatory purposes only and are not intended to limit the scope of the present disclosure.

A first aspect of the present disclosure provides a NdFeB magnet, which includes main phase grains, thin layer grain boundary phases, and triangular grain boundary phases. The NdFeB magnet comprises R, B, Co, Cu, Ga, M2, M3 and Fe. The content of R is in the range of 28 to 33 wt %. The content of B is in the range of 0.84 to 0.94 wt %. The content of Co is in the range of 0.05 to 1 wt %. The content of Cu is in the range of 0.05 to 0.55 wt %. The content of Ga is in the range of 0.3 to 0.6 wt %. The content of M2 is in the range of 0 to 0.55 wt %, where M2 is selected from one or both of Al and Sn. The content of M3 is in the range of 0.1 to 0.6 wt %, where M3 is selected from one or both of Zr and Ti. The content of Fe is in the range of 66 to 70 wt %.

R represents rare earth element that includes at least Pr and Nd. The triangular grain boundary phase includes an R₆T₁₃M₁ phase, which contains M and T. The M includes two or more elements selected from Al, Cu, Ga, Ti, Sn, and/or Zr. T includes Fe and/or Co. The percentage of the sum of the areas of all R₆T₁₃M₁ phases within the cross-section of the microstructure of the NdFeB magnet relative to the total area of the cross-section of said microstructure ranges from 5.20% to 8.40%.

To reduce the usage of heavy rare earth elements, when the present disclosure employs a formulation system with lower B content and higher Ga content, the magnet with lower B content exhibits higher sensitivity to temperature. In mass production, slight variations in B content may lead to consistency issues in the magnets. Typically, the instability in the preparation method can be mitigated by adding a certain amount of high-melting-point metals (such as Ti, Zr, Nb, etc.) to form compounds like ZrB₂ and TiB₂ at the grain boundaries in the triangular region. However, the addition of high-melting-point elements may reduce the remanence of the magnet. This disclosure effectively optimizes the microstructure of the magnet by reasonably adjusting the content of elements such as B, Cu, Co, and Al in the raw material composition and combining specific sintering and aging processes. In particular, by adding only a small amount of high-melting-point metals and utilizing specific sintering and aging treatment processes, the proportion of the R₆T₁₃M₁ phase is increased, promoting the uniform distribution of Cu, Ga, and Co elements within the R₆T₁₃M₁ phase, thereby achieving a significant improvement in the remanence and coercivity of the NdFeB magnet.

The NdFeB magnet includes main phase grains, thin layer grain boundary phases, and triangular grain boundary phases. The thin layer grain boundary phase refers to the boundary phase formed between two adjacent main phase grains, and the triangular grain boundary phase refers to the boundary phase surrounded by three or more main phase grains.

In some embodiments, R does not contain heavy rare earth elements. In the absence of heavy rare earth elements, the present disclosure effectively enhances the remanence and coercivity of the NdFeB magnet.

According to an embodiment of the present disclosure, the NdFeB magnet comprises R, B, Co, Cu, Al, Ga, M3 and Fe. The content of R is in the range of 28 to 31 wt %. The content of B is in the range of 0.84 to 0.92 wt %. The content of Co is in the range of 0.05 to 0.6 wt %. The content of Cu is in the range of 0.3 to 0.55 wt %. The content of Al is in the range of 0 to 0.35 wt %. The content of Ga is in the range of 0.3 to 0.48 wt %. The content of M3 is in the range of 0.15 to 0.3 wt %. The content of Fe is in the range of 66 to 70 wt %.

To reduce the usage of heavy rare earth elements, a formulation system with lower B content and higher Ga content is required. In particular, for the preparation of NdFeB magnets with lower rare earth content and higher remanence, it has been discovered that when the NdFeB magnet composition has a higher Cu content and a lower Al content, the triangular grain boundary region of the magnet tends to form R-rich phases characterized by Cu enrichment. The presence of R-rich phases is detrimental to the formation of the R₆T₁₃M₁ phase, which should ideally have a uniform distribution of rare earth elements and elements such as Cu and Co, thereby limiting the enhancement of the NdFeB magnet's coercivity. The quantity and uniform distribution of the R₆T₁₃M₁ phase significantly influence the coercivity of the NdFeB magnet.

The present disclosure effectively optimizes the microstructural organization of the NdFeB magnet by reasonably controlling the contents of B, Cu, Co, Al, and Ga in the raw materials, in conjunction with a three-stage aging process. In particular, after the three-stage aging process, the R-rich phase characterized by Cu enrichment within the NdFeB magnet undergoes intergranular reactions and is transformed into the R₆T₁₃M₁ phase. This not only increases the proportion of the R₆T₁₃M₁ phase but also promotes the redistribution of elements such as Cu and Co, resulting in a reduction of Cu and/or Ga content in the R-rich phase while increasing the content of Cu and/or Co in the R₆T₁₃M₁ phase. This finely tuned control of the NdFeB magnet's grain boundary structure effectively enhances the coercivity of the NdFeB magnet.

In some embodiments, the composition of the NdFeB magnet comprises R. The content of R is in the range of 28 to 31 wt %. For example, it can be 28.0 wt %, 28.2 wt %, 28.5 wt %, 28.8 wt %, 29.0 wt %, 29.2 wt %, 29.5 wt %, 29.8 wt %, 30.0 wt %, 30.2 wt %, 30.5 wt %, 30.8 wt %, 31.0 wt %, or any value within the range formed by these values.

In some embodiments, the composition of the NdFeB magnet comprises B. The content of B is in the range of 0.84 to 0.92 wt %. It can be 0.84 wt %, 0.85 wt %, 0.86 wt %, 0.87 wt %, 0.88 wt %, 0.89 wt %, 0.90 wt %, 0.91 wt %, 0.92 wt %, or any value within the range formed by these values.

In some embodiments, the composition of the NdFeB magnet comprises Co. The content of Co is in the range of 0.05 to 0.6 wt %. For example, it can be 0.05 wt %, 0.10 wt %, 0.15 wt %, 0.20 wt %, 0.25 wt %, 0.30 wt %, 0.35 wt %, 0.40 wt %, 0.45 wt %, 0.50 wt %, 0.55 wt %, 0.60 wt %, or any value within the range formed by these values.

In some embodiments, the composition of the NdFeB magnet comprises Cu. The content of Cu is in the range of 0.3 to 0.55 wt %. For example, it can be 0.30 wt %, 0.32 wt %, 0.35 wt %, 0.38 wt %, 0.40 wt %, 0.42 wt %, 0.45 wt %, 0.48 wt %, 0.50 wt %, 0.52 wt %, 0.55 wt %, or any value within the range formed by these values.

In some embodiments, the composition of the NdFeB magnet comprises Al. The content of Al is in the range of 0 to 0.35 wt %. For example, it can be 0.05 wt %, 0.10 wt %, 0.15 wt %, 0.20 wt %, 0.25 wt %, 0.30 wt %, 0.35 wt %, or any value within the range formed by these values.

In some embodiments, the composition of the NdFeB magnet comprises Ga. The content of Ga is in the range of 0.3 to 0.48 wt %. For example, it can be 0.05 wt %, 0.30 wt %, 0.32 wt %, 0.35 wt %, 0.38 wt %, 0.40 wt %, 0.42 wt %, 0.45 wt %, 0.48 wt %, or any value within the range formed by these values.

In some embodiments, the composition of the NdFeB magnet comprises M3. The content of M3 is in the range of 0.15 to 0.30 wt %. For example, it can be 0.15 wt %, 0.16 wt %, 0.18 wt %, 0.20 wt %, 0.22 wt %, 0.24 wt %, 0.26 wt %, 0.28 wt %, 0.30 wt %, or any value within the range formed by these values.

In some embodiments, the distribution of the triangular grain boundary phase satisfies: the percentage of the area of all triangular grain boundary phases within the cross-section of the microstructure of the NdFeB magnet relative to the total area of said cross-section ranging from 6.5% to 8.5%; and the triangular grain boundary phase including the R₆T₁₃M₁ phase and the R-rich phase. For example, the percentage of the area of all triangular grain boundary phases within the cross-section of the microstructure of the NdFeB magnet relative to the total area of said cross-section can be 6.5%, 6.6%, 6.7%, 6.8%, 6.9%, 7.0%, 7.1%, 7.2%, 7.3%, 7.4%, 7.5%, 7.6%, 7.7%, 7.8%, 7.9%, 0.0%, 8.1%, 8.2%, 8.3%, 8.4%, 8.5%, or any value within the range formed by these values.

The R₆T₁₃M₁ phase appears as a gray grain boundary phase in microstructural cross-sectional images, where the atomic percentage of the rare earth element R ranges from 20% to 31%. The R₆T₁₃M₁ phase includes T, with the atomic percentage of T ranging from 60% to 75%, where T comprises Fe and/or Co. The M is selected from one or more of Al, Cu, Ga, Ti, Sn, Zr, and Nb.

The R-rich phase appears as a white grain boundary phase in microstructural cross-sectional images, where the atomic percentage of the rare earth element R ranges from 39% to 69%. The R-rich phase includes T, with the atomic percentage of T ranging from 14% to 61%, where T comprises Fe and/or Co.

In some embodiments, the distribution of the R₆T₁₃M₁ phase satisfies: in the microstructural cross-section of the NdFeB magnet, the percentage of the total area of all R₆T₁₃M₁ phases in the total area of the cross-section ranging from 5.90% to 8.4%. For example, the percentage of the total area of all R₆T₁₃M₁ phases in the total area of the cross-section can be 5.9%, 6.0%, 6.2%, 6.4%, 6.6%, 6.8%, 7.0%, 7.2%, 7.4%, 7.6%, 7.8%, 8.0%, 8.2%, 8.3%, 8.4%, or any value within the range formed by these values.

In some embodiments, the R₆T₁₃M₁ phase includes Cu, and the average atomic percentage of the Cu in the R₆T₁₃M₁ phase ranges from 1.5% to 7%. For example, the average atomic percentage of the Cu element in the R₆T₁₃M₁ phase can be 1.5%, 2.0%, 2.5%, 3.0%, 3.5%, 4.0%, 4.5%, 5.0%, 5.5%, 6.0%, 6.5%, 7.0%, or any value within the range formed by these values.

In some embodiments, the R-rich phase includes Cu, and the average atomic percentage of the Cu in the R-rich phase ranges from 3.5% to 11%, in some embodiments from 3.50% to 7.60%. For example, the average atomic percentage of the Cu in the R-rich phase can be 3.5%, 4.0%, 4.5%, 5.0%, 5.5%, 6.0%, 6.5%, 7.0%, 7.5%, or any value within the range formed by these values.

In some embodiments, the R₆T₁₃M₁ phase includes Co, and the average atomic percentage of the Co in the R₆T₁₃M₁ phase ranges from 0.5% to 4%. For example, the average atomic percentage of the Co in the R₆T₁₃M₁ phase can be 0.5%, 1.0%, 1.5%, 2.0%, 2.5%, 3.0%, 3.5%, 4.0%, or any value within the range formed by these values.

In some embodiments, the R-rich phase includes Ga, and the average atomic percentage of the Ga in the R-rich phase ranges from 0.3% to 1.5%. For example, the average atomic percentage of the Ga in the R-rich phase can be 0.3%, 0.5%, 0.7%, 0.9%, 1.1%, 1.3%, 1.5%, or any value within the range formed by these values.

In some embodiments, the NdFeB magnet comprises R, B, Al, Ga, Co, Cu, and Fe. The content of R is in the range of 29.5 to 32 wt %. The content of B is in the range of 0.84 to 0.92 wt %. The content of Al is in the range of 0.3 to 0.55 wt %. The content of Ga is in the range of 0.3 to 0.48 wt %. The content of Co is in the range of 0.05 to 0.6 wt %. The content of Cu is in the range of 0.05 to 0.3 wt %. The content of Fe is in the range of 66 to 70 wt %.

To reduce the usage of heavy rare earth elements, a formulation system with lower B content and higher Ga content is required. In particular, for the preparation of the NdFeB magnets with higher coercivity, it has found that when the Cu content in the NdFeB magnet composition is low and the Al content is high, the R₆T₁₃M₁ phase tends to be unevenly distributed within the NdFeB magnet. Some R₆T₁₃M₁ phases may cluster at the triangular grain boundary phases, where the proportion of the R₆T₁₃M₁ phase is low, which is unfavorable for improving the coercivity of the NdFeB magnet. Further research has revealed that the R₆T₁₃M₁ phase clustered in the triangular grain boundary phases exhibits a higher [Ga]/[M] ratio and a lower [Al]/[M] ratio, where [Ga] is the atomic percentage of Ga in the R₆T₁₃M₁ phase, [M] is the atomic percentage of M elements in the R₆T₁₃M₁ phase, and [Al] is the atomic percentage of Al in the R₆T₁₃M₁ phase. This indicates that Ga tends to be more concentrated in the R₆T₁₃M₁ phase, while the distribution of Al in the R₆T₁₃M₁ phase is relatively low.

The present disclosure effectively optimizes the microstructural organization of the NdFeB magnet by reasonably controlling the contents of B, Cu, Co, Al, and Ga in the raw materials, in conjunction with a three-stage aging process. In particular, after the three-stage aging process, the percentage of the total area of all R₆T₁₃M₁ phases within the NdFeB magnet is increased, while also promoting the redistribution of Ga. This results in a reduced [Ga]/[M] ratio and an increased [Al]/[M] ratio within the R₆T₁₃M₁ phase, thereby decreasing the concentration of the R₆T₁₃M₁ phase that is enriched at the triangular grain boundary regions of the NdFeB magnet. Consequently, this allows for fine-tuning of the grain boundary structure of the NdFeB magnet, effectively enhancing the coercivity of the NdFeB magnet.

In some embodiments, the NdFeB magnet comprises R. The content of R is in the range of 29.5 to 32 wt %. For example, it can be 29.5 wt %, 29.7 wt %, 29.9 wt %, 30.1 wt %, 30.3 wt %, 30.5 wt %, 30.9 wt %, 31.1 wt %, 31.3 wt %, 31.5 wt %, 31.7 wt %, 31.9 wt %, or any value within the range formed by these values.

In some embodiments, the NdFeB magnet comprises B. The content of B is in the range of 0.84 to 0.92 wt %. For example, it can be 0.84 wt %, 0.85 wt %, 0.86 wt %, 0.87 wt %, 0.88 wt %, 0.89 wt %, 0.90 wt %, 0.91 wt %, 0.92 wt %, or any value within the range formed by these values.

In some embodiments, the NdFeB magnet comprises Al. The content of Al is in the range of 0.3 to 0.55 wt %. For example, it can be 0.30 wt %, 0.32 wt %, 0.35 wt %, 0.38 wt %, 0.40 wt %, 0.42 wt %, 0.45 wt %, 0.48 wt %, 0.50 wt %, 0.52 wt %, 0.55 wt %, or any value within the range formed by these values.

In some embodiments, the NdFeB magnet comprises Ga. The content of Ga is in the range of 0.3 to 0.48 wt %. For example, it can be 0.30 wt %, 0.30 wt %, 0.32 wt %, 0.35 wt %, 0.38 wt %, 0.40 wt %, 0.42 wt %, 0.45 wt %, 0.48 wt %, or any value within the range formed by these values.

In some embodiments, the NdFeB magnet comprises Co. The content of Co is in the range of 0.05 to 0.6 wt %. For example, it can be 0.05 wt %, 0.10 wt %, 0.15 wt %, 0.20 wt %, 0.25 wt %, 0.30 wt %, 0.35 wt %, 0.40 wt %, 0.45 wt %, 0.50 wt %, 0.55 wt %, 0.60 wt %, or any value within the range formed by these values.

In some embodiments, the NdFeB magnet comprises Cu. The content of Cu is in the range of 0.05 to 0.3 wt %. For example, it can be 0.05 wt %, 0.08 wt %, 0.10 wt %, 0.12 wt %, 0.15 wt %, 0.18 wt %, 0.20 wt %, 0.22 wt %, 0.25 wt %, 0.28 wt %, 0.30 wt %, or any value within the range formed by these values.

In some embodiments, the NdFeB magnet comprises Ti and Zr. The weight ratio of Ti to Zr ranges from 2:1 to 4:1. For example, the weight ratio of Ti to Zr can be 2.0:1, 2.2:1, 2.4:1, 2.6:1, 2.8:1, 3.0:1, 3.2:1, 3.4:1, 3.6:1, 3.8:1, or 4.0:1.

In some embodiments, the NdFeB magnet comprises Ti or Zr. The content of Ti or Zr is in the range of 0.15 to 0.35 wt %. For example, it can be 0.15 wt %, 0.17 wt %, 0.19 wt %, 0.21 wt %, 0.23 wt %, 0.25 wt %, 0.27 wt %, 0.29 wt %, 0.31 wt %, 0.33 wt %, 0.35 wt %, or any value within the range formed by these values.

In some embodiments, the total content of impurity elements is below 2100 ppm. For example, the total content of impurity elements can be 2100 ppm, 2000 ppm, 1900 ppm, 1800 ppm, 1700 ppm, 1600 ppm, 1500 ppm, 1400 ppm, 1300 ppm, 1200 ppm, 1100 ppm, 1000 ppm, or any value within the range formed by these values.

In some embodiments, the impurity elements include one or more of C, N, and 0, with the content of O being below 750 ppm and the content of N being below 480 ppm. For example, the content of O can be 750 ppm, 700 ppm, 650 ppm, 600 ppm, 550 ppm, 500 ppm, 450 ppm, 400 ppm, 350 ppm, 300 ppm, or any value within the range formed by these values. For example, the content of N can be 480 ppm, 450 ppm, 420 ppm, 400 ppm, 380 ppm, 350 ppm, 320 ppm, 300 ppm, 280 ppm, 250 ppm, 220 ppm, 200 ppm, or any value within the range formed by these values.

In some embodiments, the distribution of the R₆T₁₃M₁ phase satisfies: the percentage of the area of all R₆T₁₃M₁ phases within the cross-section of the microstructure of the NdFeB magnet relative to the total area of said cross-section ranging from 5.3% to 7.9%. For example, it can be 5.3%, 5.5%, 5.7%, 5.9%, 6.1%, 6.3%, 6.5%, 6.7%, 6.9%, 7.1%, 7.3%, 7.5%, 7.7%, 7.8%, 7.9%, or any value within the range formed by these values.

In some embodiments, M in the R₆T₁₃M₁ phase contains Ga. [Ga] represents the atomic percentage of Ga in the R₆T₁₃M₁ phase, and [M] represents the atomic percentage of the M in the R₆T₁₃M₁ phase. The ratio of [Ga]/[M] is in the range of 0.49 to 0.61. For example, it can be 0.49, 0.51, 0.53, 0.55, 0.57, 0.59, 0.61, or any value within the range formed by these values.

In some embodiments, M in the R₆T₁₃M₁ phase contains Al. [Al] represents the atomic percentage of Al in the R₆T₁₃M₁ phase, and [M] represents the atomic percentage of the M in the R₆T₁₃M₁ phase. The ratio of [Al]/[M] is in the range of 0.32 to 0.45. For example, it can be 0.32, 0.34, 0.36, 0.38, 0.40, 0.42, 0.44, 0.45, or any value within the range formed by these values.

According to the second aspect of the present disclosure, the present disclosure provides a method for preparing a NdFeB magnet, which includes the following steps:
producing rapidly solidified alloy sheets from alloy raw materials using a rapid solidification process;
subjecting the rapidly solidified alloy sheets to hydrogen explosion milling and air jet milling to obtain alloy powder, where the average particle size D50 of the alloy powder is between 3 and 5 μm;
pressing the alloy powder into shape under magnetic field orientation, with a magnetic field strength of 1.4 to 2.5 T, to obtain a green compact, or performing isostatic pressing after pressing the alloy powder into shape under magnetic field orientation to obtain a green compact;
placing the green compact into a sintering furnace and conducting sintering and aging process in a vacuum or inert atmosphere to obtain the NdFeB magnet;
where the aging process is a three-stage aging process: the first stage aging performed at a temperature in a range of 800 to 950° C. with a holding time of 0.5 to 4 hours; second stage aging performed at a temperature in a range of 450 and 550° C. with a holding time of 2 to 10 hours; and the third stage aging performed at a temperature in a range of 600 and 700° C., with a holding time of 2 to 10 hours.

The present disclosure effectively optimizes the microstructural organization of the NdFeB magnet by reasonably controlling the contents of B, Cu, Co, Al, and Ga in the raw materials, in conjunction with a three-stage aging process. In particular, after the three-stage aging process, the percentage of the total area of all R₆T₁₃M₁ phases within the NdFeB magnet is increased, while also promoting the redistribution of elements such as Cu and Co. This results in a decrease in the Cu content within the R-rich phase and an increase in the Cu and Co content within the R₆T₁₃M₁ phase, allowing for the fine-tuning of the grain boundary structure of the NdFeB magnet, thereby effectively enhancing the coercivity of the NdFeB magnet.

In some embodiments, predetermined combination of raw materials is based on the composition of the NdFeB magnet as outlined in the first aspect of the present disclosure.

In some embodiments, in the three-stage aging process, the first stage aging process is conducted at a temperature of 800 to 950° C. for a holding time of 0.5 to 4 hours. For example, the temperature for the first aging step can be 800° C., 820° C., 850° C., 880° C., 900° C., 920° C., 950° C., or any value within the range formed by these values. For example, the holding time for the first aging step can be 0.5 hours, 1 hour, 1.5 hours, 2 hours, 2.5 hours, 3 hours, 3.5 hours, 4 hours, or any value within the range formed by these values.

In some embodiments, the second stage aging process is conducted at a temperature of 450 to 550° C. for a holding time of 2 to 10 hours. For example, the temperature for the second aging step can be 450° C., 460° C., 470° C., 480° C., 490° C., 500° C., 510° C., 520° C., 530° C., 540° C., 550° C., or any value within the range formed by these values. For example, the holding time for the second aging step can be 2 hours, 3 hours, 4 hours, 5 hours, 6 hours, 7 hours, 8 hours, 9 hours, 10 hours, or any value within the range formed by these values.

In some embodiments, the third stage aging process is conducted at a temperature of 600 to 700° C. for a holding time of 2 to 10 hours. For example, the temperature for the third aging step can be 600° C., 610° C., 620° C., 630° C., 640° C., 650° C., 660° C., 670° C., 680° C., 690° C., 700° C., or any value within the range formed by these values. For example, the holding time for the third aging step can be 2 hours, 3 hours, 4 hours, 5 hours, 6 hours, 7 hours, 8 hours, 9 hours, 10 hours, or any value within the range formed by these values.

In some embodiments, the aging process includes the following steps: cooling to a temperature range of 150 to 250° C. after the second stage aging process, with a cooling rate of 3 to 8° C./min; and cooling to room temperature after the third stage aging process, with a cooling rate of 3 to 8° C./min. For example, the cooling rate after the second stage aging process can be 3.0° C./min, 3.5° C./min, 4.0° C./min, 4.5° C./min, 5.0° C./min, 5.5° C./min, 6.0° C./min, 6.5° C./min, 7.0° C./min, 7.5° C./min, 8.0° C./min, or any value within the range formed by these values. For example, the cooling rate after the third stage aging process can be 3.0° C./min, 3.5° C./min, 4.0° C./min, 4.5° C./min, 5.0° C./min, 5.5° C./min, 6.0° C./min, 6.5° C./min, 7.0° C./min, 7.5° C./min, 8.0° C./min, or any value within the range formed by these values.

In some embodiments, the rapid solidification process includes melting the alloy raw materials in a vacuum induction melting furnace, with a melting temperature between 1400° C. and 1500° C. The molten liquid is then cast onto a copper roll to obtain rapidly solidification alloy sheets with a thickness of 0.15 to 0.4 mm. For example, the melting temperature can be 1400° C., 1410° C., 1420° C., 1430° C., 1440° C., 1450° C., 1460° C., 1470° C., 1480° C., 1490° C., 1500° C., or any value within the range formed by these values.

In some embodiments, the parameters for the sintering treatment include: a sintering temperature between 1030° C. and 1120° C., and a sintering time of 4 to 12 hours, in some embodiments 6 to 12 hours. For example, the sintering temperature can be 1030° C., 1040° C., 1050° C., 1060° C., 1070° C., 1080° C., 1090° C., 1100° C., 1110° C., 1120° C., or any value within the range formed by these values. For example, the sintering time can be 4 hours, 5 hours, 6 hours, 7 hours, 8 hours, 9 hours, 10 hours, 11 hours, 12 hours, or any value within the range formed by these values.

In some embodiments, the sintering treatment includes a two-stage sintering process: the sintering temperature for the first stage is between 1030° C. and 1120° C., with a sintering time of 4 to 12 hours; the sintering temperature for the second stage is 10 to 15° C. lower than that of the first stage, and the sintering time for the second stage is reduced by 1 to 3 hours compared to the first stage. For example, the sintering temperature for the first stage can be 1030° C., 1040° C., 1050° C., 1060° C., 1070° C., 1080° C., 1090° C., 1100° C., 1110° C., 1120° C., or any value within the range formed by these values. For example, the sintering time for the first stage can be 4 hours, 5 hours, 6 hours, 7 hours, 8 hours, 9 hours, 10 hours, 11 hours, 12 hours, or any value within the range formed by these values.

In some embodiments, the sintering treatment includes a two-stage sintering process: the sintering temperature for the second stage is between 1015° C. and 1110° C., and the sintering time for the second stage is from 1 to 11 hours. For example, the sintering temperature for the second stage can be 1015° C., 1020° C., 1030° C., 1040° C., 1050° C., 1060° C., 1070° C., 1080° C., 1090° C., 1100° C., 1110° C., or any value within the range formed by these values. For example, the sintering time for the second stage can be 1 hour, 2 hours, 3 hours, 4 hours, 5 hours, 6 hours, 7 hours, 8 hours, 9 hours, 10 hours, 11 hours, or any value within the range formed by these values.

In some embodiments, the sintering treatment includes a two-stage sintering process, which includes a cooling process between the first stage sintering and the second stage sintering. The cooling rate is between 4° C. and 9° C. per minute, and the heating rate after cooling is between 8° C. and 12° C. per minute; in some embodiments, the heating rate after cooling is higher than the cooling rate. For example, the cooling rate between the first stage sintering and the second stage sintering can be 4.0° C./min, 4.5° C./min, 5.0° C./min, 5.5° C./min, 6.0° C./min, 6.5° C./min, 7.0° C./min, 7.5° C./min, 8.0° C./min, 8.5° C./min, 9.0° C./min, or any value within the range formed by these values. For example, the heating rate between the first stage sintering and the second stage sintering can be 8.0° C./min, 8.5° C./min, 9.0° C./min, 9.5° C./min, 10.0° C./min, 10.5° C./min, 11.0° C./min, 11.5° C./min, 12.0° C./min, or any value within the range formed by these values.

In some embodiments, the sintering treatment includes a two-stage sintering process: after the second stage sintering, an inert gas, such as argon, is introduced to cool the material to room temperature before proceeding with subsequent aging treatment.

To enhance the stability, consistency, and yield of batch products of the NdFeB magnet, the present disclosure controls the sintering process by adopting a two-stage sintering method. The sintering temperature of the second stage is reduced by 10° C. to 15° C. compared to the first stage, and the sintering time for the second stage is decreased by 1 to 3 hours relative to the first stage. The process between the first stage sintering and the second stage sintering includes a cooling process, and in some embodiments the heating rate is higher than the cooling rate. Through the adjustments made in the sintering process, uniform grain growth is achieved, resulting in refined grains that ensure the main phase is uniform and defect-free, thereby laying the foundation for precise control of the boundary phases during the subsequent aging process.

In a two-stage aging process, it becomes difficult to control the reaction of the boundary phases. During the process, the Ga elements tend to aggregate, leading to an uneven distribution of the R₆T₁₃M₁ phase, which results in larger R₆T₁₃M₁ phases and a deterioration in the overall squareness of the NdFeB magnet, accompanied by lower coercivity. When the second stage aging process in a low-temperature in this disclosure is conducted, it further promotes the sufficient flow of the liquid phase, allowing for the even distribution of low-melting-point elements and rare earth elements. Subsequently, during the third stage aging process, some of the main phase participates in the reaction. The Al elements within the participating main phase can partially replace Ga elements in the liquid phase, working in conjunction with the Ga elements already present in the boundary phases for compositional reconfiguration. During the subsequent solidification of the liquid phase, both Ga and Al elements enter the R₆T₁₃M₁ phase, enhancing the role of Ga in the formation of the boundary phases. This results in smaller, uniformly distributed R₆T₁₃M₁ phases, thereby increasing the proportion of the R₆T₁₃M₁ phase and improving the demagnetization coupling effect. This facilitates precise structural control of the magnetic boundary, contributing to enhancements in coercivity and squareness of the NdFeB magnet. Specifically, this is evidenced by a decrease in the [Ga]/[M] ratio and an increase in the [Al]/[M] ratio in the elements characteristic of the boundary phases of the NdFeB magnet.

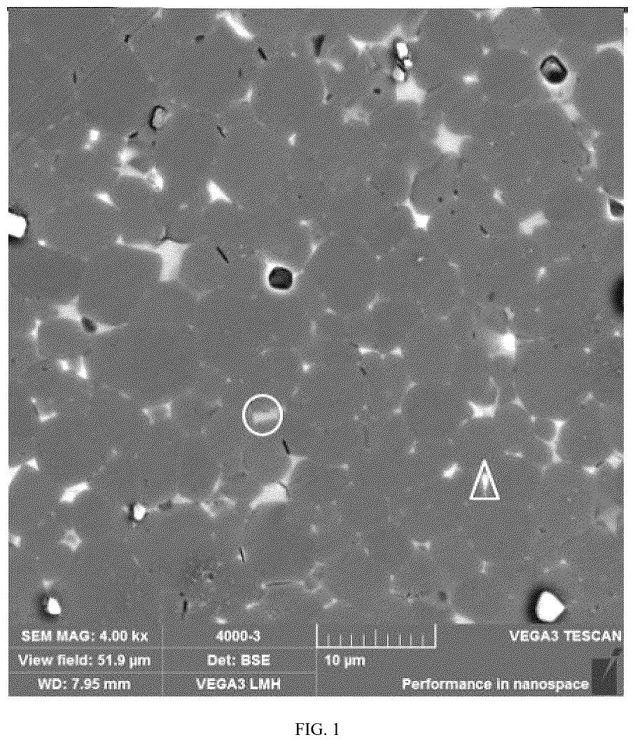

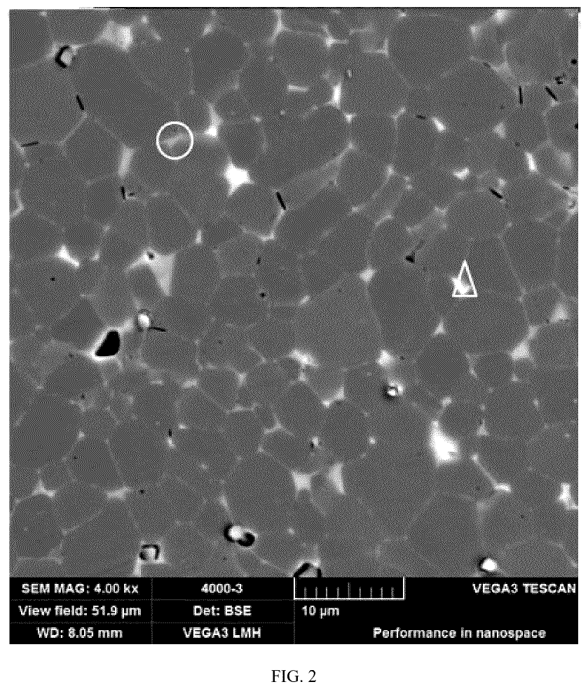

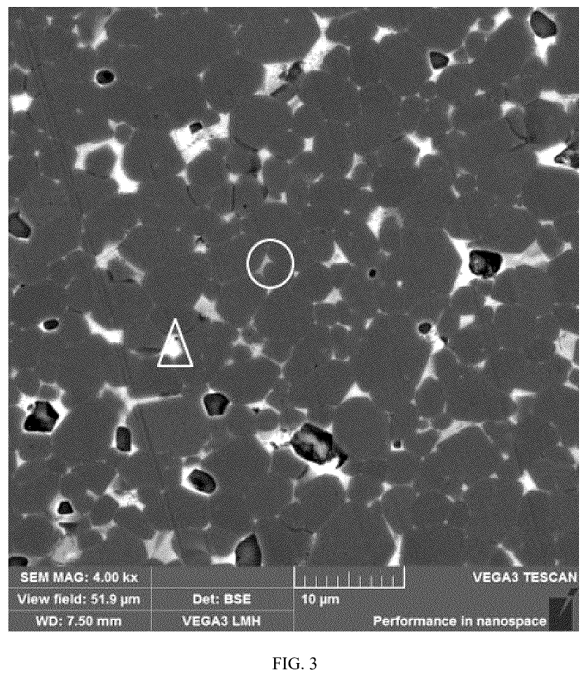

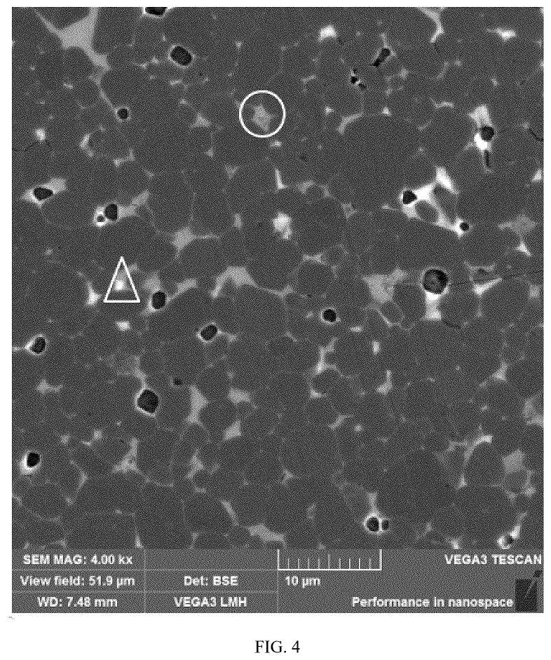

The testing methods employed in this disclosure are as follows:
microstructural analysis method: after NdFeB magnet sample preparation, scanning electron microscopy (SEM) is conducted on more than ten arbitrary cross-sections of the NdFeB magnet that are perpendicular to the orientation direction. For each microstructural cross-section, a statistical analysis is performed on the boundary phases within all triangular regions. The area percentage of all triangular boundary phases in each cross-section relative to the total area of the cross-section is calculated. The average value of these percentages across all cross-sections is then determined, representing the area percentage of all triangular boundary phases in the cross-section of the NdFeB magnet. The dimensions of the observation areas are, for example, 40 μm×40 μm and 75 μm×75 μm, with magnifications ranging from 2000 to 5000 times. Image-Pro Plus image analysis software is utilized for statistical analysis. Based on image contrast, the R₆T₁₃M₁ phase is identified as a gray boundary phase, while the R-rich phase is identified as a white boundary phase. This allows for the determination of the area percentage of all R₆T₁₃M₁ phases in the cross-section of the NdFeB magnet. As illustrated in FIGS. 1-4, the triangular boundary phase marked with o corresponds to the R₆T₁₃M₁ phase, and the triangular boundary phase marked with Δ corresponds to the R-rich phase. Energy Dispersive Spectroscopy (EDS) is employed to analyze the atomic percentages of elements in the R₆T₁₃M₁ phase and R-rich phase within the NdFeB magnet, obtaining elemental data from at least 20 points. The [Ga]/[M] and [Al]/[M] ratios are calculated for each point, and the average values are derived from the data. The magnetic properties of the NdFeB magnet are measured using a B-H curve measurement device (NIM-200).

The present disclosure will be further illustrated by the following embodiments; however, the present disclosure is not limited in any way by these embodiments.

### Embodiment 1-1

Alloy raw material composition of NdFeB magnet is as follows:

| PrNd | B | Co | Ga | Cu | Al | Ti | |
|---|---|---|---|---|---|---|---|
| wt % | wt % | wt % | wt % | wt % | wt % | wt % | Fe |
| 29.5 | 0.84 | 0.5 | 0.3 | 0.4 | 0 | 0.2 | bal |

(“bal” in this disclosure means remaining balance amount.)

The alloy raw materials prepared according to the above composition are subjected to a rapid solidification process to produce rapid solidification alloy sheets. The alloy raw materials are melted in a vacuum induction melting furnace at a melting temperature of 1500° C., and the molten liquid is cast onto a copper roller to obtain a rapid solidification alloy sheet with a thickness of 0.25 mm.

The rapid solidification alloy sheets are then subjected to hydrogen fragmentation and micronization to obtain alloy powder. The hydrogen fragmentation is performed at a hydrogen absorption pressure of 0.3 MPa and a dehydrogenation temperature of 560° C. Micronization is carried out using an air jet mill with a grinding pressure of 0.68 MPa, resulting in an alloy powder with an average particle size (D50) of 4 μm.

The alloy powder is subjected to a forming process: the alloy powder is pressed into shape under a magnetic field orientation, with a magnetic field strength of 1.5 T to obtain a green compact.

The green compact is placed in a sintering furnace for sintering and aging treatment in a vacuum or inert atmosphere, ultimately producing a NdFeB magnet. The parameters for the sintering treatment are as follows: a sintering temperature of 1060° C. and a sintering time of 8 hours.

The aging process employs a three-stage aging treatment: the temperature is raised to 900° C. at a rate of 7° C./min for a first-stage aging treatment lasting 2 hours. After cooling to 200° C., the temperature is increased to 500° C. at a rate of 5° C./min for a second-stage aging treatment lasting 6 hours. Following this, the temperature is cooled to 200° C. and then increased to 630° C. at a rate of 5° C./min for a third-stage aging treatment lasting 6 hours, after which the sample is cooled to room temperature to obtain the NdFeB magnet.

### Embodiment 1-2

### Alloy Raw Material Composition of NdFeB Magnet is as Follows:

| PrNd | B | Co | Ga | Cu | Al | Ti | |
|---|---|---|---|---|---|---|---|
| wt % | wt % | wt % | wt % | wt % | wt % | wt % | Fe |
| 30 | 0.84 | 0.6 | 0.48 | 0.55 | 0.1 | 0.2 | bal |

The specific preparation methods for Embodiment 1-2 are identical to those of Embodiment 1-1.

### Embodiment 1-3

### Alloy Raw Material Composition of NdFeB Magnet is as Follows:

| PrNd | B | Co | Ga | Cu | Al | Zr | |
|---|---|---|---|---|---|---|---|
| wt % | wt % | wt % | wt % | wt % | wt % | wt % | Fe |
| 29.5 | 0.92 | 0.6 | 0.48 | 0.3 | 0.35 | 0.15 | bal |

The specific preparation methods for Embodiment 1-3 are identical to those of Embodiment 1-1.

### Comparative Embodiment 1-1

Using the same alloy raw material composition of NdFeB magnet as in Embodiment 1-1, the preparation steps, except for the aging treatment, are identical to those in Embodiment 1-1. The only difference is that the aging treatment employs a conventional two-stage aging process: the aging treatment includes a first-stage aging treatment conducted at a temperature of 890° C. for 4 hours, followed by a second-stage aging treatment at a temperature of 500° C. for 8 hours, resulting in the NdFeB magnet.

### Comparative Embodiment 1-2

Using a alloy raw material composition that is different from that of Embodiment 1-1, the preparation steps are identical to those in Embodiment 1-1.

### Alloy Raw Material Composition of NdFeB Magnet is as Follows:

| PrNd | B | Co | Ga | Cu | Al | Ti | Zr | |
|---|---|---|---|---|---|---|---|---|
| wt % | wt % | wt % | wt % | wt % | wt % | wt % | wt % | Fe |
| 29.5 | 0.95 | 1 | 0.6 | 0.3 | 0.4 | 0.3 | 0.35 | bal |

The magnetic performance test data for Embodiments 1-1 to 1-3 and Comparative Embodiments 1-1 to 1-2 are as follows:

| | Remanence | Coercivity | |
|---|---|---|---|
| Samples | Br/kGs | HCJ/kOe | Hk/HCJ |
| Embodiment 1-1 | 14.40 | 18.26 | 99.4% |
| Embodiment 1-2 | 14.21 | 17.86 | 99.1% |
| Embodiment 1-3 | 14.05 | 17.56 | 99.1% |
| Comparative | 14.37 | 13.78 | 98.3% |
| Embodiment 1-1 | | | |
| Comparative | 13.81 | 18.01 | 97.6% |
| Embodiment 1-2 | | | |

The microstructural analysis results for Embodiment 1-1 and Comparative Embodiment 1-1 are as follows: in Embodiment 1-1, the percentage of the area occupied by all triangular grain boundary phases in the cross-section of the NdFeB magnet is 7.29%. The triangular grain boundary phases in Embodiment 1-1 include the R₆T₁₃M₁ phase and the R-rich phase. The area occupied by all R₆T₁₃M₁ phases in the cross-section of the NdFeB magnet in Embodiment 1-1 accounts for 6.29% of the total cross-sectional area. In Comparative Embodiment 1-1, the percentage of the area occupied by all triangular grain boundary phases in the cross-section of the NdFeB magnet is 5.03%, and the area occupied by all R₆T₁₃M₁ phases in this cross-section accounts for 4.03% of the total cross-sectional area.

The R-rich phase (white grain boundary phase) in Embodiment 1-1 contains Cu, with an average atomic percentage of 5.26%. The R₆T₁₃M₁ phase (gray grain boundary phase) in Embodiment 1-1 also contains Cu, with an average atomic percentage of 4.01%. In Comparative Embodiment 1-1, the R-rich phase (white grain boundary phase) contains Cu, with an average atomic percentage of 14.37%, while the R₆T₁₃M₁ phase (gray grain boundary phase) contains Cu, with an average atomic percentage of 0.65%.

The R₆T₁₃M₁ phase in Embodiment 1-1 contains Co, with an average atomic percentage of 1.62%. In Comparative Embodiment 1-1, the R₆T₁₃M₁ phase also contains Co, with an average atomic percentage of 0.24%.

The R-rich phase in Embodiment 1-1 contains Ga, with an average atomic percentage of 0.56%. In Comparative Embodiment 1-1, the R-rich phase contains Ga, with an average atomic percentage of 1.39%.

According to the above description, Comparative Embodiment 1-1 utilizes the same composition of NdFeB magnet as Embodiment 1-1 but employs a conventional two-stage aging process. The area percentage of the triangular grain boundary phases and the area percentage of the R₆T₁₃M₁ phase in the NdFeB magnet obtained from Comparative Embodiment 1-1 are significantly lower than the corresponding data of Embodiment 1-1. Compared to Comparative Embodiment 1-1, the R₆T₁₃M₁ phase (gray grain boundary phase) in Embodiment 1-1 exhibits a notably higher concentration of Cu and Co elements, while the R-rich phase in Embodiment 1-1 contains a relatively lower concentration of Ga. From the magnetic performance data, Comparative Embodiment 1-1 demonstrates a significantly lower coercivity of 13.78 kOe and a squareness ratio of 98.3% compared to the respective values of each implementation.

Comparative Embodiment 1-2 employs a different composition of NdFeB magnet than Embodiment 1-1 but follows the same preparation steps as Embodiment 1-1. From the magnetic performance data, Comparative Embodiment 1-2 shows a significantly lower remanence of 13.81 kGs and a squareness ratio of 97.6% compared to the values of each implementation.

### Embodiment 2-1

### Alloy Raw Material Composition of NdFeB Magnet is as Follows:

| PrNd | B | Co | Ga | Cu | Al | Ti | |
|---|---|---|---|---|---|---|---|
| wt % | wt % | wt % | wt % | wt % | wt % | wt % | Fe |
| 30.5 | 0.88 | 0.6 | 0.3 | 0.1 | 0.3 | 0.2 | bal |

The alloy raw materials prepared according to the above composition are subjected to a rapid solidification process to produce rapid solidification alloy sheets. The alloy raw materials are melted in a vacuum induction melting furnace at a melting temperature of 1450° C., and the molten liquid is cast onto a copper roller to obtain a rapid solidification alloy sheet with a thickness of 0.25 mm.

The rapid solidification alloy sheets are then subjected to hydrogen fragmentation and micronization to obtain alloy powder. The hydrogen fragmentation is performed at a hydrogen absorption pressure of 0.3 MPa and a dehydrogenation temperature of 560° C. Micronization is carried out using an air jet mill with a grinding pressure of 0.68 MPa, resulting in an alloy powder with an average particle size (D50) of 4 μm.

The alloy powder is subjected to a forming process: the alloy powder is pressed into shape under a magnetic field orientation, with a magnetic field strength of 1.4 T to obtain a green compact.

The green compact is placed in a sintering furnace for sintering and aging treatment in a vacuum or inert atmosphere, ultimately producing a NdFeB magnet.

The sintering process employs a two-stage sintering method. After sintering at a temperature of 1070° C. for 6 hours, argon gas is introduced to cool the material to 450° C. Subsequently, the temperature is raised to 1060° C. at a rate of 10° C. per minute for secondary sintering for 5 hours. The material is then cooled to room temperature under an argon atmosphere to obtain the sintered green body.

The aging process employs a three-stage aging treatment: the temperature is raised to 900° C. at a rate of 7° C./min for a first-stage aging treatment lasting 2 hours. After cooling to 200° C., the temperature is increased to 500° C. at a rate of 5° C./min for a second-stage aging treatment lasting 6 hours. Following this, the temperature is cooled to 200° C. and then increased to 630° C. at a rate of 5° C./min for a third-stage aging treatment lasting 6 hours, after which the sample is cooled to room temperature to obtain the NdFeB magnet.

### Embodiment 2-2

### Alloy Raw Material Composition of NdFeB Magnet is as Follows:

| PrNd | B | Co | Ga | Cu | Al | Ti | |
|---|---|---|---|---|---|---|---|
| wt % | wt % | wt % | wt % | wt % | wt % | wt % | Fe |
| 29.5 | 0.84 | 0.6 | 0.35 | 0.2 | 0.55 | 0.15 | bal |

The specific preparation methods for Embodiment 2-2 are identical to those of Embodiment 2-1.

### Embodiment 2-3

### Alloy Raw Material Composition of NdFeB Magnet is as Follows:

| PrNd | B | Co | Ga | Cu | Al | Ti | Zr | |
|---|---|---|---|---|---|---|---|---|
| wt % | wt % | wt % | wt % | wt % | wt % | wt % | wt % | Fe |
| 30.5 | 0.84 | 0.6 | 0.48 | 0.25 | 0.4 | 0.2 | 0.1 | bal |

The specific preparation methods for Embodiment 2-3 are identical to those of Embodiment 2-1.

### Comparative Embodiment 2-1

Using the same alloy raw material composition of NdFeB magnet as in Embodiment 2-1, the preparation steps, except for the sintering process and aging treatment, are the same as those in Embodiment 2.

The only difference is that the sintering process and aging treatment employ a conventional sintering process and a two-stage aging process, respectively. The conventional sintering process involves sintering at a temperature of 1050° C. for 10 hours. The aging treatment consists of a first-stage aging process and a second-stage aging process, with the first-stage aging occurring at a temperature of 890° C. for 4 hours, and the second-stage aging occurring at a temperature of 500° C. for 8 hours, resulting in the NdFeB magnet.

### Comparative Embodiment 2-2

Using a alloy raw material composition that is different from that of Embodiment 2-1, the preparation steps are identical to those in Embodiment 2-1.

### Alloy Raw Material Composition of NdFeB Magnet is as Follows:

| PrNd | B | Co | Ga | Cu | Al | Ti | Zr | |
|---|---|---|---|---|---|---|---|---|
| wt % | wt % | wt % | wt % | wt % | wt % | wt % | wt % | Fe |
| 29.5 | 0.94 | 0.6 | 0.48 | 0.4 | 0.2 | 0.45 | 0.2 | bal |

The magnetic performance test data for Embodiments 2-1 to 2-3 and Comparative Embodiments 2-1 to 2-2 are as follows:

| | Remanence | Coercivity | |
|---|---|---|---|
| Samples | Br/kGs | HCJ/kOe | Hk/HCJ |
| Embodiment 2-1 | 13.77 | 17.90 | 99.6% |
| Embodiment 2-2 | 13.81 | 17.32 | 98.9% |
| Embodiment 2-3 | 13.65 | 19.15 | 98.6% |
| Comparative | 13.74 | 17.31 | 98.2% |
| Embodiment 2-1 | | | |
| Comparative | 14.12 | 16.15 | 97.5% |
| Embodiment 2-2 | | | |

The results of the microstructure tests for Embodiment 2-1 and Comparative Embodiment 2-1 are as follows:
the boundary phase in the triangular region of Embodiment 2-1 includes the R₆T₁₃M₁ phase. In the cross-section of the NdFeB magnet of Example 2-1, the area percentage of all R₆T₁₃M₁ phases relative to the total cross-sectional area is 7.40%. The boundary phase in the triangular region of Comparative Embodiment 2-1 also includes the R₆T₁₃M₁ phase, with the area percentage of all R₆T₁₃M₁ phases in the cross-section of the NdFeB magnet being 5.20%.

The R₆T₁₃M₁ phase in Embodiment 2-1 contains Ga and Al, with an atomic ratio of [Ga]/[M]=0.51 and an atomic ratio of [Al]/[M]=0.41. In the R₆T₁₃M₁ phase of Comparative Example 2-1, Ga and Al are also present, with an atomic ratio of [Ga]/[M]=0.65 and an atomic ratio of [Al]/[M]=0.30.

As stated above, Comparative Embodiment 2-1 uses the same magnet formulation as Embodiment 2-1, but employs a conventional sintering process and a two-stage aging process.

The area percentage of the R₆T₁₃M₁ phase in the NdFeB magnet obtained in Comparative Embodiment 2-1 is significantly lower at 5.20% compared to the corresponding data of 7.40% in Embodiment 2-1. Compared to Comparative Embodiment 2-1, Embodiment 2-1 exhibits a relatively higher [Al]/[M] ratio and a relatively lower [Ga]/[M] ratio. From the magnetic performance data, Comparative Embodiment 2-1 has a relatively low coercivity of 17.31 kOe and a significantly lower squareness of 98.2% compared to various examples.

Comparative Embodiment 2-2 employs a different magnet formulation from Embodiment 2-1, but the preparation steps are the same as those in Embodiment 2-1. In terms of magnetic performance data, Comparative Embodiment 2-2 exhibits notably lower coercivity of 16.15 kOe and squareness of 97.5% compared to the various examples.

It should also be noted that the various specific technical features described in the above-mentioned specific embodiments can be combined in any suitable manner, provided that there are no contradictions. To avoid unnecessary repetition, the present disclosure does not elaborate on all possible combinations.

Moreover, any combination of the various different embodiments of the present disclosure is also permissible, as long as it does not contravene the spirit of the disclosure, and such combinations should also be considered as part of the content disclosed by the present disclosure.

1. A NdFeB magnet comprising main phase grains, thin-layer grain boundary phases, and triangular grain boundary phases, wherein:
the NdFeB magnet includes R, B, Co, Cu, Ga, M2, M3, and Fe, wherein:
a content of R in the NdFeB magnet is in a range of 28 to 32 wt %, where R represents a rare earth element, and R includes at least Pr and Nd;
a content of B in the NdFeB magnet is in a range of 0.84 to 0.94 wt %;
a content of Cu in the NdFeB magnet is in a range of 0.05 to 0.55 wt %;
a content of Co in the NdFeB magnet is in a range of 0.05 to 1 wt %;
a content of Ga in the NdFeB magnet is in a range of 0.3 to 0.6 wt %;
a content of M2 in the NdFeB magnet is in a range of 0 to 0.55 wt %, where M2 represents one or more selected from Al and Sn;
a content of M3 in the NdFeB magnet is in a range of 0.1 to 0.6 wt %, where M3 represents one or more selected from Zr and Ti; and
a content of Fe in the NdFeB magnet is in a range of 66 to 70 wt %;
the triangular grain boundary phases include R₆T₁₃M₁ phase, where the R₆T₁₃M₁ phase includes M and T, where the M includes any two or more selected from Al, Cu, Ga, Ti, Sn, and/or Zr, and the T includes Fe and/or Co; and
a total area of the R₆T₁₃M₁ phase within a microscopic structure cross-section of the NdFeB magnet is in a range of 5.2% to 8.4% of a total cross-sectional area of the microscopic structure cross-section.

2. The NdFeB magnet according to claim 1, wherein in the NdFeB magnet:
the content of R is in a range of 28 to 31 wt %;
the content of B is in a range of 0.84 to 0.92 wt %;
the content of Co is in a range of 0.05 to 0.6 wt %;
the content of Cu is in a range of 0.3 to 0.55 wt %;
a content of Al is in a range of 0 to 0.35 wt %;
the a content of Ga is in a range of 0.3 to 0.48 wt %;
the content of M3 is in a range of 0.15 to 0.3 wt %; and
the content of Fe is in a range of 66 to 70 wt %.

3. The NdFeB magnet according to claim 2, wherein the R₆T₁₃M₁ phase includes Cu, and an average atomic percentage of Cu in the R₆T₁₃M₁ phase is in a range of 1.5 at % to 7 at %.

4. The NdFeB magnet according to claim 2, wherein:
a total area of all triangular grain boundary phases within the microscopic structure cross-section of the NdFeB magnet is in a range of 6.5% to 8.5% of the total cross-sectional area;
the triangular grain boundary phases further include R-rich phase; and
the total area of the R₆T₁₃M₁ phase within the microscopic structure cross-section is in a range of 5.9% to 8.4% of the total cross-sectional area.

5. The NdFeB magnet according to claim 4, wherein the R-rich phase includes Cu, and an average atomic percentage of Cu in the R-rich phase is in a range of 3.50 at % to 11.00 at %.

6. The NdFeB magnet according to claim 4, wherein R-rich phase includes Ga, and an average atomic percentage of Ga in the R-rich phase is in a range of 0.3 at % to 1.5 at %.

7. The NdFeB magnet according to claim 4, wherein the R₆T₁₃M₁ phase includes Co, and an average atomic percentage of Co in the R₆T₁₃M₁ phase is in a range of 0.5 at % to 4 at %.

8. The NdFeB magnet according to claim 1, wherein in the NdFeB magnet:
the content of R is in a range of 29.5 to 32 wt %;
the content of B is in a range of 0.84 to 0.92 wt %;
a content of Al is in a range of 0.3 to 0.55 wt %;
the content of Ga is in a range of 0.3 to 0.48 wt %;
the content of Co is in a range of 0.05 to 0.6 wt %;
the content of Cu is in a range of 0.05 to 0.3 wt %; and
the content of Fe is in a range of 66 to 70 wt %.

9. The NdFeB magnet according to claim 8, wherein:
the total area of all R₆T₁₃M₁ phases within the microscopic structure cross-section is in a range of 5.3% to 7.9% of the total cross-sectional area.

10. The NdFeB magnet according to claim 9, wherein
the R₆T₁₃M₁ phase includes Ga; and
a ratio [Ga]/[M] is in a range of 0.49 to 0.61, where:
[Ga] represents an atomic percentage of Ga in the R₆T₁₃M₁ phase; and
[M] represents an atomic percentage of M in the R₆T₁₃M₁ phase.

11. The NdFeB magnet according to claim 9, wherein
the R₆T₁₃M₁ phase includes Al; and
a ratio [Al]/[M] is in a range of 0.32 to 0.45, where:
[Al] represents an atomic percentage of Al in the R₆T₁₃M₁ phase; and
[M] represents an atomic percentage of M in the R₆T₁₃M₁ phase.

12. The NdFeB magnet according to claim 1, wherein R does not contain heavy rare earth elements.

13. A method for preparing the NdFeB magnet according to claim 1, comprising:
producing rapidly solidified alloy sheets from alloy raw materials using a rapid solidification process;
subjecting the rapidly solidified alloy sheets to hydrogen explosion milling and air jet milling to obtain alloy powder, where an average particle size D50 of the alloy powder is in a range of 3 to 5 μm;
pressing the alloy powder under magnetic field orientation, with a magnetic field strength of 1.4 to 2.5 T, to obtain a green compact, or performing isostatic pressing after pressing the alloy powder under magnetic field orientation to obtain the green compact;
placing the green compact into a sintering furnace and conducting sintering and aging process in a vacuum or inert atmosphere to obtain the NdFeB magnet;
wherein the aging process is a three-stage aging process including:
a first stage aging performed at a temperature in a range of 800 to 950° C. with a holding time of 0.5 to 4 hours;
a second stage aging performed at a temperature in a range of 450 and 550° C. with a holding time of 2 to 10 hours; and
a third stage aging performed at a temperature in a range of 600 and 700° C., with a holding time of 2 to 10 hours.

14. The method according to claim 13, wherein the aging process further includes:
cooling to a temperature range of 150 to 250° C. after the second stage aging, with a cooling rate of 3 to 8° C./min; and
cooling to room temperature after the third stage aging, with a cooling rate of 3 to 8° C./min.
